(19) United States
(12) Patent Application Publication
(10) Pub. No.: US 2016/0309699 A1
(43) Pub. Date: Oct. 27, 2016

(54) Shooting strap and game drag apparatus

(71) Applicant: Timothy S. O'Donnell, Oxford, WI (US)

(72) Inventor: Timothy S. O'Donnell, Oxford, WI (US)

(21) Appl. No.: 14/545,323

(22) Filed: Apr. 22, 2015

(51) Int. Cl. A01M 31/00; F41A 35/00

(52) U.S. Cl. CPC A01M 31/00; A01M 31/006; F41A 35/00

(57) ABSTRACT

A shooting strap and game drag apparatus includes a radius-adjustable first strap member. A second strap member is connected to the first strap member, and a plurality of hand/wrist reception loops are connected to longitudinally sequential locations along the second strap member. In a first mode of use, the first strap member is secured to a tree trunk, and the shooter holds a firearm and selects a hand/wrist reception loop on the second strap member to provide aim stabilization of the firearm via tension in the second strap. In a second dual mode of use, the first strap member is removed from the tree and secured to the neck of a game animal, and the shooter grabs a portion of the second strap member and pulls on the second strap member, thereby facilitating transportation of the animal such as by dragging the game animal along the ground.

### BACKGROUND OF THE INVENTION

1. Field of the Invention

The present invention relates generally to devices that assist a shooter of a firearm, and, more particularly, to assist a shooter of a firearm which is especially adapted for stabilizing the shooter's aim.

2. Description of the Prior Art

Devices for assisting a hunter are well known in the art. In this respect, throughout the years, a number of innovations have been developed relating to devices for assisting hunters in correctly aiming their weapon, and the following U.S. patents are representative of some of those innovations: U.S. Pat. No. 2,985,980; 4,722,501; 5,056,253; 5,685,103; and 6,243,979.

U.S. Pat. No. 2,985,980 discloses a handgun stabilization which is in the form of a flexible harness adapted to be secured at one end to the gun and at the other hand to engage about the neck of the gun user.

U.S. Pat. No. 4,722,501 discloses a bow hanger in the form of a steel rod adapted to be secured to a tree proximal to the bow user.

U.S. Pat. No. 5,056,253 discloses a handgun stabilization which employs a strap portion that is supported by the neck of a shooter. As discussed above with respect to U.S. Pat. No. 2,985,980, no stationary tree is employed to improve aiming of a firearm.

U.S. Pat. No. 5,685,103 discloses a tree-supported gun support which supports a gun from the scope of the gun. A metal rod supports the gun at a distance from the tree. Because a scope is employed to support a firearm, there is a possibility that the operation of the scope would be interfered with by its support. Moreover, many firearms do not employ either a scope at all or one that would be amenable to being used to support the firearm. In this respect, it would be desirable for a device for improving the aiming of a firearm not employ a scope of the firearm.

U.S. Pat. No. 6,243,979 discloses a portable rifle rest for use with a deer stand. The deer stand is supported by a tree, and the rifle rest is supported by the tree-supported deer stand. Other than providing a mere rifle rest, there are no other features provided that are designed to improve the aim of a firearm by a shooter.

There is another feature that would be desirable in a device that improves the aim of a shooter. More specifically, once a game animal is shot, a problem arises for transporting the shot animal to another location. None of the patents cited hereinabove disclose such a desirable feature. In this respect, it would be desirable for a device that improves the aim of a shooter to also possess characteristics that facilitate the transportation of the shot animal.

Thus, while the foregoing body of prior art indicates it to be well known to use devices to assist a shooter of a firearm to improve one's aim, the prior art described above does not teach or suggest a shooting strap and game drag apparatus which has the following combination of desirable features: (1) stabilizes the aiming of a firearm by being stabilized by a stationary tree; (2) provides a flexible harness for assisting in the aiming a firearm; (3) improves the aiming of a firearm without employing a scope of the firearm; and (4) improves the aim of a shooter and also possesses characteristics that facilitate the transportation of a shot animal.

The foregoing desired characteristics are provided by the unique shooting strap and game drag apparatus of the present invention as will be made apparent from the following description thereof. Other advantages of the present invention over the prior art also will be rendered evident below.

### SUMMARY OF THE INVENTION

To achieve the foregoing and other advantages, the present invention, briefly described, provides a shooting strap and game drag apparatus which includes a radius-adjustable first strap member. A second strap member is connected to the first strap member, and a plurality of hand/wrist reception loops are connected at longitudinally sequential locations along the second strap member.

Preferably, an adjustment buckle is connected to the first strap member for securing a selected radius-adjustment of the first strap member.

If desired, the second strap member can be connected to the first strap member by means of a hand/wrist reception loop on the second strap member.

In a first mode of use, the first strap member is secured to a tree trunk, and the shooter holds a firearm and selects a preferred hand/wrist reception loop on the second strap member. In this way, the hand of the shooter is steadied and stabilized when taking aim on a game animal.

In a second mode of use, the first strap member is removed from the tree and secured to the neck of a game animal, and the shooter grabs a portion of the second strap member and pulls on the second strap member. Then, the shooter, or another person, can drag the game animal along the ground to transport the animal to another location.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved shooting strap and game drag apparatus which has all of the advantages of the prior art and none of the disadvantages.

It is another object of the present invention to provide a new and improved shooting strap and game drag apparatus which may be easily and efficiently manufactured and marketed.

It is a further object of the present invention to provide a new and improved shooting strap and game drag apparatus which is of durable and reliable construction.

An even further object of the present invention is to provide a new and improved shooting strap and game drag apparatus which is susceptible of a low cost of manufacture with regard to both materials and labor, and which accordingly is then susceptible of low prices of sale to the consuming public, thereby making such shooting strap and game drag apparatus available to the buying public.

Still yet a further object of the present invention is to provide a new and improved shooting strap and game drag apparatus which stabilizes the aiming of a firearm by being stabilized by a stationary tree.

Still another object of the present invention is to provide a new and improved shooting strap and game drag apparatus that employs a flexible harness for assisting in the aiming of a firearm.

Yet another object of the present invention is to provide a new and improved shooting strap and game drag apparatus which improves the aiming of a firearm without employing a scope of the firearm.

Even another object of the present invention is to provide a new and improved shooting strap and game drag apparatus that improves the aim of a shooter and also possesses characteristics that facilitate the transportation of a shot animal.

Still yet another object of the present invention is to provide a shooting strap and game drag apparatus which includes a radius-adjustable first strap member, a second strap member connected to the first strap member, and a plurality of hand/wrist reception loops connected at longitudinally sequential locations along the second strap member.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a side view showing a preferred embodiment of the shooting strap and game drag apparatus of the invention by which is a first strap member is supported by a tree trunk and a second strap member is being used by a shooter aiming a firearm.

FIG. 2 is a side view of the embodiment of the shooting strap and game drag apparatus shown in FIG. 1, removed from the tree trunk and the shooter.

FIG. 3 is a top view of the embodiment of the shooting strap and game drag apparatus of FIG. 2 taken along line 3-3 thereof.

FIG. 4 is an enlarged side view of the first strap member embodiment of the invention shown in FIG. 3, wherein the first strap member is in an open condition.

FIG. 5 is an enlarged side view of the second strap member embodiment of the invention shown in FIG. 3, wherein the second strap member is removed from the first strap member.

FIG. 6 is a view of the embodiment of the invention shown in FIGS. 1-5, wherein the invention is used by the shooter to drag a game animal.

### DESCRIPTION OF THE PREFERRED EMBODIMENT

With reference to the drawings, a new and improved shooting strap and game drag apparatus embodying the principles and concepts of the present invention will be described.

Turning to FIGS. 1-6, there is shown a preferred embodiment of the shooting strap and game drag apparatus of the invention generally designated by reference numeral 10. In each of the figures, reference numerals are shown that correspond to like reference numerals that designate like elements shown in other figures.

In the preferred embodiment, shooting strap and game drag apparatus 10 includes a radius-adjustable first strap member 12, a second strap member 14 connected to the first strap member 12, and a plurality of hand/wrist reception loops 16 connected at longitudinally sequential locations along the second strap member 14.

In the preferred embodiment depicted, second strap 14 preferably terminates in a first loop 16 at one end, and also terminates in a second loop at the opposed other end of the second strap 14. Longitudinally and sequentially located between first and second terminating loops 16, are third, fourth and fifth hand/wrist reception loops 16, substantially as shown. Preferably, loops 16 are juxtaposed relative to each other, adjacent loops abut one another, and collectively, the loops 16 extend from and along only one side of strap 14, more or less as illustrated in FIGS. 1-6.

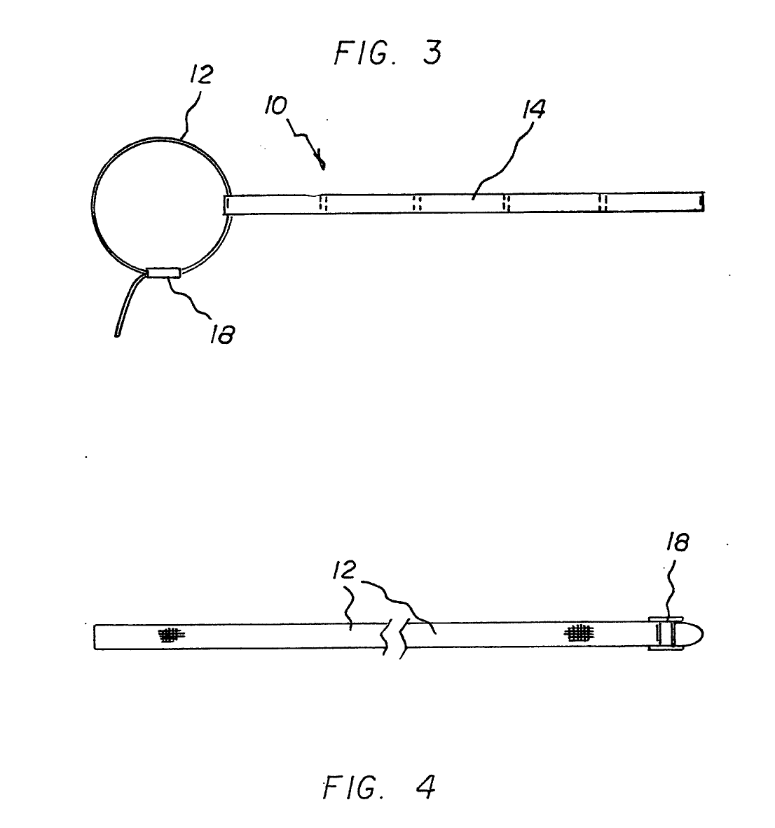

In this regard, it will be observed that the imaginary central axis of the opening defined by each hand/wrist reception loop 16, respectively, lies substantially normal or perpendicular to the longitudinal axis of the second strap 14. It is to be understood that the length of the second strap 14 and the number of hand/wrist reception loops 16 located longitudinally and sequentially on the second strap member 14 can be varied to suit individual convenience. Preferably, and substantially as shown, the individual loops 16 have the same transverse extent (width) as the second strap 14 (FIG. 3), and are of similar material having similar thickness, though not necessarily. The loops 16 are large enough in diameter to easily axially receive the hand and wrist of an adult shooter (FIG. 1).

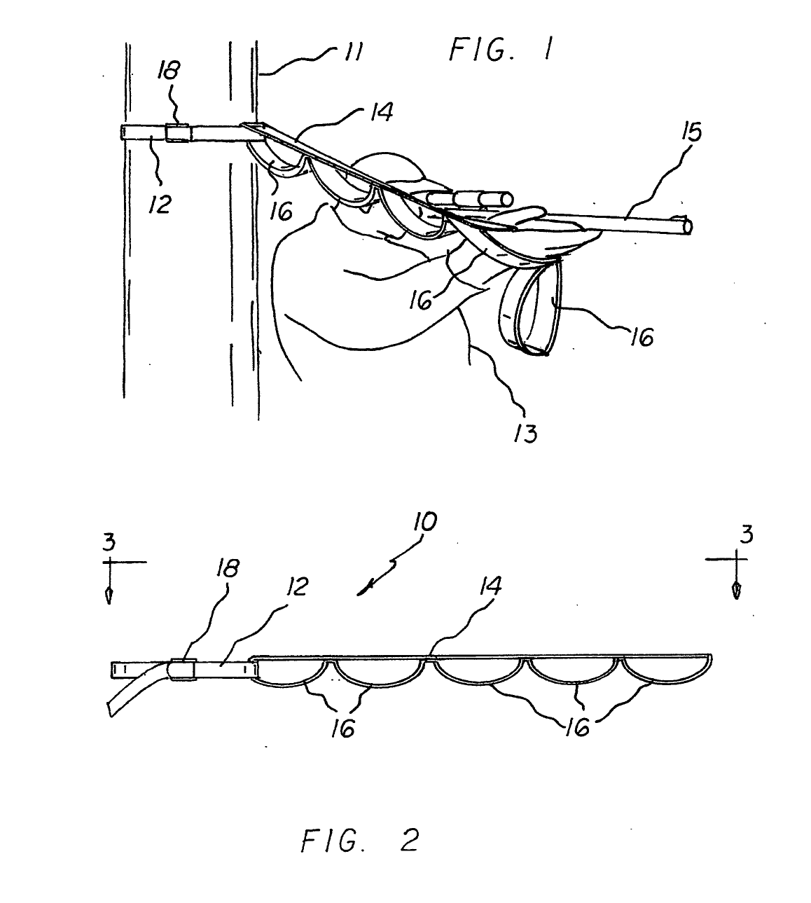

Preferably, both first and second straps 12, 14 are fabricated from the same known woven or non-woven fabric material of either natural or synthetic material. The selected fabric material is lightweight, waterproof and durable enough for use outdoors. The hand/wrist reception loops 16 preferably may be formed by taking strips of the same fabric material used for strap members 12, 14 and sewing the strips in place on one side of the strap member 14 to form the shape substantially depicted in FIGS. 2 and 5.

Alternatively, a single strip of material may be sewn or otherwise fastened to strap member 14 at several spaced seam locations along the longitudinal extent of strap member 14, to form the individual hand/wrist reception loops 16.

The shooting strap and game drag apparatus 10 can be designated as the Steady Strap™ shooting strap and deer drag. The first strap member 12 can be referred to as a tree strap, cinch strap, or game, animal strap, e.g. deer strap. The second strap member 14 can be referred to as the shooting or tension strap. A hand/wrist reception loop 16 can be referred to as a shooting strap loop.

Preferably, an adjustment buckle 18 is connected to the first strap member 12 for securing or cinching a selected radius-adjustment of the first strap member 12.

If desired, the second strap member 14 can be connected to the first strap member 12 by means of one of the first or second terminal hand/wrist reception loops 16, substantially as depicted. That is, the first strap member 12 is inserted through the first loop 16 before the first strap member is secured to a stationary object (FIGS. 1 and 2).

As shown in FIG. 1, a primary use of the shooting strap and game drag apparatus 10 of the invention is for stabilizing a firearm 15 in the hands of a shooter or gun user 13.

More specifically, the first strap member 12 first is secured to a tree trunk 11 by first having two ends of the first strap member 12 separated from each other, as shown in FIG. 4. Then, the first strap member 12 is wrapped around the tree trunk 11, preferably at a location on the tree trunk 11 which is above the head of the shooter 13, as shown in FIG. 1.

One free end of the first strap member 12 then is threaded through the adjustment buckle 18, clasp, or other suitable strap securing device. Next, the first strap member 12 is tightened around the tree trunk 11, and the first strap member 12 is maintained in the tightened condition around the tree trunk 11, above the head of the shooter 13, by means of the adjustment buckle 18. It is to be appreciated that adjustment buckle 18 can be any conventional strap buckle or cinch device, the details of which are beyond the scope of the present invention.

Then, the shooter 13 holds the firearm 15 and places one hand through a specific selected hand/wrist reception loop 16, as shown in FIG. 1. In this respect, the hand of the shooter's forearm that supports the firearm 15 is the hand that grasps the selected hand/wrist reception loop 16. The specific hand/wrist reception loop 16 is selected for the convenience and the comfort of the shooter 13.

As the shooter 13 holds the firearm 15, he exerts a pulling tension on the second strap 14 extending from the tree trunk 11, along the longitudinal axis of the second strap member 14, and through the selected hand/wrist reception loop 16 to the hand of the shooter 13 and the forearm grip of the rifle or gun (FIG. 1). This tension provides excellent stability and steadiness for the arm of the shooter 13 while he holds the firearm 15 in a selected position and orientation for aiming the firearm 15 at a game animal 19. By virtue of the present invention, and if desired, the shooter 13 can maintain tension on the second strap 14 while he easily moves around the tree, thus maintaining a stabilized field of fire of 360°.

Alternatively, the first strap member 12 can be fixed to portions of a tree stand, such as shooting rails (not shown).

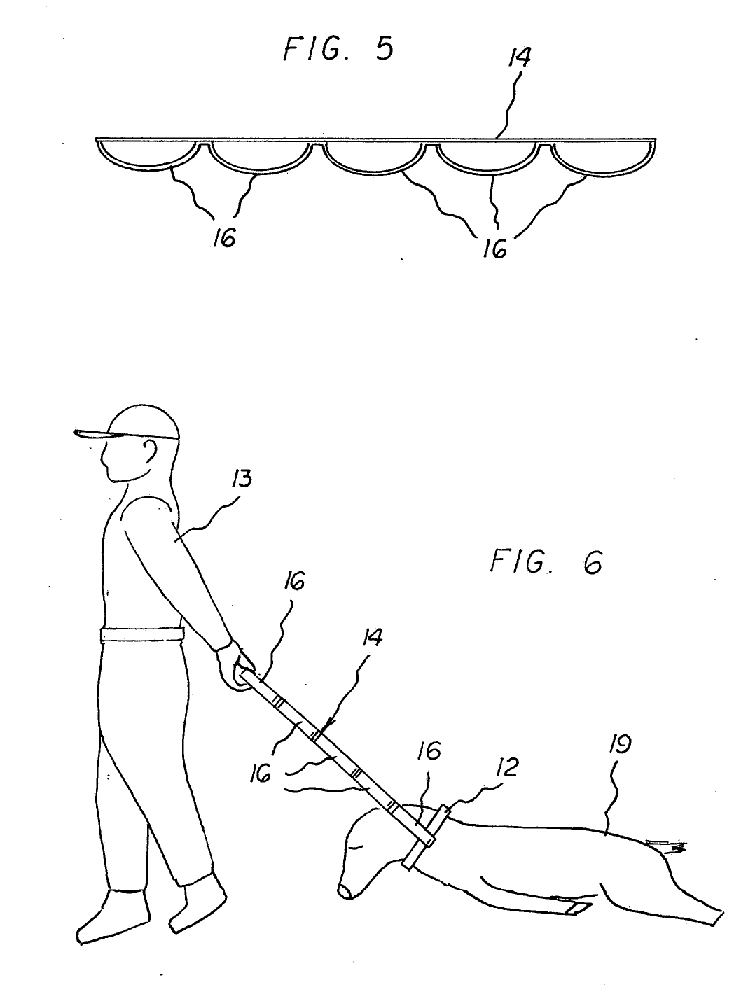

In FIG. 6, there is shown the use of the shooting strap and game drag apparatus 10 in another mode of use, which is for dragging a shot game animal 19 along the ground or other generally horizontal surface. In this respect, the first strap member 12 is removed from the tree trunk 11, and the first strap member 12 is placed around the neck, or other body part, of the game animal 19. Then, the first strap member 12 is tightened around the neck of the game animal 19 for proper radius-adjustment of the first strap member 12 around the game animal's neck. The adjustment buckle 18 is used to secure the adjusted and tightened first strap member 12 to the neck of the game animal 19.

By grabbing the distal end of the second strap member 14, such as at the distal hand/wrist reception loop 16, the shooter 13 or other person is able to pull the hand/wrist reception loop 16, the second strap member 14, the first strap member 12, and the game animal 19 in order to drag the game animal 19 along the ground.

With another mode of using the subject invention, with the first strap member 12 being secured to the game animal 19, such as by the neck or the feet, the game animal 19 can be hung from an elevated support, such as a tree branching by tying the second strap member 14 to the tree branch.

The game animal 19 can be any desired animal, such as a deer, which may be too heavy for the shooter 13 to carry.

Although the hand/wrist reception loops 16 preferably are attached to the second strap member 14 by sewn stitches, any suitable means, such as rivets, adhesives, or other known attaching means may be used instead.

The first strap member 12, the second strap member 14, and the hand/wrist reception loops 16 can be made from any suitable strong material, such as nylon, rubberized fabric material, or other water-resistant and rot-resistant materials. Such materials because of texture aid in the shooter 13 gripping the hand/wrist reception loops 16.

The dimensions of the components of the shooting strap and game drag apparatus 10 can be any suitable dimensions. Exemplary dimensions are as follows merely to illustrate the invention: (i) the second strap member 14 can be 2 inches wide and 4 feet in length; and (ii) the first strap member or cinch strap 12 can also be 2 inches wide and about six 6 feet in length.

The flat “straps” shown in the drawing Figures can also be in the form of cylindrical ropes, if desired. More specifically, cylindrical ropes are also understood herein to be included in the term “straps”.

In summary, the present invention creates a three point brace for the hunter or shooter. The hunter simple pulls on the Steady Strap™ shooting strap attached to a tree or like support (via first strap member 12) and creates a “three point brace” which consists of the tree (or other stationary support), shoulder and forearm. By use of the present invention, hunters will improve their accuracy of fire, and in so doing harvest more game ethically.

It is apparent from the above that the present invention accomplishes all of the objects set forth by providing a new and improved shooting strap and game drag apparatus that is low in cost, relatively simple in design and operation, and which may advantageously be used to (1) stabilize the aiming of a firearm by being stabilized by a stationary tree; (2) provide a flexible harness for assisting in the aiming a firearm; (3) improve the aiming of a firearm without employing a scope of the firearm; and (4) improve the aim of a shooter and also possess characteristics that facilitate the transportation of a shot animal.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

The manner of usage and operation of the instant invention is believed apparent from the above disclosure, and accordingly, no further discussion relative to the manner of usage and operation need be provided.

The foregoing detailed description is considered as illustrative only of the principles of the invention. Numerous modifications and changes will readily occur to those skilled in the art and therefore, it is not desired to limit the invention to the exact construction and operation shown and described. Accordingly, all suitable modifications and equivalents falling within the broad scope of the subject matter described above may be resorted to in carrying out the present invention.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A shooting strap and game drag apparatus, comprising:
a radius-adjustable first strap member, and
a second strap member adapted to be connected to said first strap member,
a plurality of hand/wrist reception loops on said second strap member, said plurality of hand/wrist reception loops being connected to said second strap member at longitudinal sequential locations along said second strap member,
wherein said plurality of hand/wrist reception loops comprises a first hand/wrist reception loop and at least a second hand/wrist reception loop longitudinally spaced from said first hand/wrist reception loop on said second strap member,
and wherein said radius-adjustable first strap member is adapted to be connected to said second strap member by being inserted through a selected one of said first hand/wrist reception loop or said at least second hand-wrist reception loop such that said radius-adjustable first strap member is capable of being anchored to a stationary object by said first radius adjustable strap to enable application of tension to said second strap by a shooter engaging said one of said first hand/wrist reception loop or said at least second hand-wrist reception loop not so selected.

2. The apparatus of claim 1, further including:
an adjustment buckle connected to said first strap member for securing a selected radius-adjustment of the first strap member.

3. (canceled)

4. The apparatus of claim 1, wherein said second strap member is adapted to be connected to said first strap member by means of a selected hand/wrist reception loop located at one end of said second strap member and wherein either said first hand/wrist selection loop or said at least second hand/wrist selection loop is located at said one end of said second strap.

5. The apparatus of claim 1 wherein said second strap member has a transverse extent, and wherein each ones of said plurality of hand/wrist reception loops has a transverse extent substantially equal to said transverse extent of said second strap member.

6. The apparatus of claim 1 wherein said second strap member has a first side and an opposed second side and the plurality of hand/wrist reception loops extend from said second side in juxtaposed relation to one another.

7. The apparatus of claim 1 wherein said plurality of hand/wrist reception loops comprises a first hand/wrist reception loop located at one end of said second strap, a second hand/wrist reception loop located at the opposed other end of said second strap member, and at least a third hand/wrist reception loop located on said second strap member longitudinally spaced between said first hand/wrist reception loop and said second hand/wrist reception loop, and
wherein said radius-adjustable first strap member is adapted to be connected to said second strap member by being inserted through a selected one of said first hand/wrist reception loop or said at least second hand-wrist reception loop or said at least third hand/wrist reception loop such that said radius-adjustable first strap member is capable of being anchored to a stationary object to enable application of tension to said second strap by a shooter engaging said one of said first hand/wrist reception loop or said second hand/wrist reception loop or said at least third hand/wrist reception loop not so selected.

8. The apparatus of claim 7 further including a fourth hand/wrist reception loop and a fifth hand/wrist reception loop connected to said second strap member in a juxtaposed relation to said first, second and said at least third hand/wrist reception loops.

9. The apparatus of claim 1 wherein said first strap member and said second strap member are fabricated from a fabric material.

10. The apparatus of claim 8 wherein the first, second, third, fourth and fifth hand/wrist reception loops extend longitudinally sequentially along said second strap member in a mutually abutting manner.

11. The apparatus of claim 6 where said plurality of hand/wrist reception loops defines respective openings sized to receive the hand/wrist of a hunter, and wherein the imaginary central axis of each said loop is substantially perpendicular to the longitudinal axis of said second strap.

12. The apparatus of claim 1 wherein said plurality of hand/wrist reception loops on said second strap member comprises a strip of material fastened to said second strap at spaced seam locations along the longitudinal extent of said second strap to form said hand/wrist reception loops.
